(19) United States
(12) Patent Application Publication
(10) Pub. No.: US 2009/0019131 A1
(43) Pub. Date: Jan. 15, 2009

(54) Method and system for keeping personalized settings across network

(75) Inventor: Prasanna Ganesan, Menlo Park, CA (US)

Correspondence Address: SHEMWELL MAHAMEDI LLP, 4880 STEVENS CREEK BOULEVARD, SUITE 201, SAN JOSE, CA, 95129-1034, US

(73) Assignee: VVOND, LLC

(21) Appl. No.: 11/465,434

(22) Filed: Aug. 17, 2006

Related U.S. Application Data
(63) Continuation-in-part of application No. 11/075,573, filed on Mar. 9, 2005.

(51) Int. Cl. G06F 15/16; H04N 7/173

(52) U.S. Cl. 709/217; 725/87

(57) ABSTRACT

Techniques for keeping personalized settings across network are disclosed. According to one aspect of the present invention, personalized settings (e.g., parameters or table) are managed in a primary client device associated with a subscriber. A copy of the copy of personalized settings is maintained in a server. When it is detected that the subscriber is logged on in a different client device (e.g., a box), a copy of the personalized settings is uploaded to the different client device that is configured to respond to the personalized settings. As a result, the subscriber sees the familiar settings on the different client device.

### CROSS-REFERENCE TO RELATED APPLICATION

This is a continuation-in-part of co-pending U.S. application Ser. No. 11/075,573, entitled “Continuous data feeding in a distributed environment” and filed Mar. 9, 2005, and by at least one of the co-inventors herein.

### BACKGROUND

1. Technical Field

The present invention relates generally to the area of delivering multimedia services over the Internet, and more particularly to techniques for maintaining personal settings regardless of where a user is logged on.

2. Description of the Related Art

Computers are ubiquitous these days. However most users still desire to access their own computers across a network. One of the reasons is the familiar settings personalized by a user on his/her own computer, which helps the user locate or act on readily what is needed. For example, every user has his/her own settings in a windows environment (e.g., Microsoft Windows XP), for example, particular colors, fonts, background, icons, and etc, none being identical. These settings are typically evolving as the time goes. When a user goes on a new computer, it is not trivial to duplicate exactly the settings of an old computer personalized by the user over the time. Some software tools (e.g., ImageGhost) are sometimes needed.

In the area of receiving multimedia services via a receiver, the personal settings for the receiver can be more important because each user has his/her own settings as to which types of movies/music to receive or not to receive, which ones are more preferable than others, and etc. In some cases, the personal settings define how a local personalized library in the library being offered is created, formed and maintained. These settings provide a convenient environment to access the services more effectively and more personally. However the settings are generally not portable, which means they lose the effectiveness when the user goes on a different receiver.

There, thus, is a need for techniques that enable the portability of such settings so that a user can always have the personalized settings regardless of which receiver is being used.

### SUMMARY

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

Broadly speaking, the present invention is related to techniques for keeping personalized settings across network. According to one aspect of the present invention, personalized settings (e.g., parameters or table) are managed in a primary client device associated with a subscriber. A copy of the copy of personalized settings is maintained in a server. When it is detected that the subscriber is logged on in a different client device (e.g., a box), a copy of the personalized settings is uploaded to the different client device that is configured to respond to the personalized settings. As a result, the subscriber sees the familiar settings on the different client device.

According to another aspect of the present invention, some of the personalized settings pertain to a vault associated with the subscriber. Movies in the vault may be purchased or rented and shall be accessed whenever and wherever the subscriber may desire. Although, these movies in the vault may be watched, making a copy on an optical medium (e.g., a DVD disc) would require that the data for a movie is all locally available. Without impacting any possible access to the movies in the value, the different client device is configured in accordance with the personalized settings to fetch missing data segments for the movies in the vault wherever there is an available bandwidth in the downloading path.

Other aspects of the invention will become apparent and appreciated by those skilled in the art from the detailed description herein. Embodiments of the invention may be implemented in numerous ways, including a method, system, device, or a computer readable medium. Several embodiments of the invention are discussed below. According to one embodiment, the invention provides a method for managing personalized settings, the method comprises determining whether a user has logged into a box other than a primary box, where the primary box is configured to manage personalized settings that dictate a graphic user interface from which the user accesses various media services; and when the user is logged into the box other than the primary box, uploading a copy of the personalized settings to the box that is configured to respond to the personalized settings such that the user sees substantially similar settings as if the user has logged into the primary box.

According to another embodiment, the invention provides a system for managing personalized settings, the apparatus comprises: a first box configured to manage personal settings for an account associated with a user, wherein the personalized settings dictate a graphic user interface from which the user accesses various media services; a second box, operating independently from the first box, being logged in by the user; and a server determining whether the user has logged into the first box or the second box when receiving a login request, when the user is logged into the second box, the server uploading a copy of the personalized settings to the second box that is configured to respond to the personalized settings such that the user sees substantially similar settings as if the user has logged into the first box.

Accordingly one of the objects of the present inventions is to provide techniques for maintaining personal settings regardless of where a user is logged on.

Other objects, features, advantages, benefits of the invention will become more apparent from the following detailed description of a preferred embodiment, which proceeds with reference to the accompanying drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows an exemplary configuration in which the present invention may be practiced;

FIG. 2A shows an exemplary display showing a list of services provided by a service provider;

FIG. 2B shows an exemplary display, also referred to as a home display, that may be provided after the user enters Watch a Movie of FIG. 2A;

FIG. 2C shows a display including a list of movie titles in My Movies, wherein the movie titles are presented respectively in movie banners;

FIG. 2D shows a display including a viewing history in My Movies to show what movie a user has ordered or watched;

FIG. 3A shows an exemplary configuration to implement one embodiment of the present invention;

FIG. 3B shows an embodiment in which a file is being organized or fragmented in terms of four segments;

FIG. 3C shows another embodiment in which a file is being organized or fragmented in terms of a header and four segments, where the header is always locally cached;

FIG. 4A shows an illustration of a personal settings table that includes a number of characters and numerals, according to one embodiment of the present invention;

FIG. 4A shows an exemplary display including a browsing panel providing several search schemes to facilitate a search process;

FIG. 4B shows a flowchart of managing personalized setting across network;

FIG. 5A, there shows exemplary source information shown as a map illustrating how a library of 5000 movie titles is distributed across N boxes.

FIG. 5B shows a source information map corresponding to FIG. 5A;

FIG. 5C shows exemplary source information with backup boxes in a table that includes a backup identifier (shown as an IP address) for each of the designated boxes;

FIG. 6A, there shows an embodiment of an ordering box retrieving and assembling segments to support a playback of a selected movie; and

FIG. 6B shows an embodiment of an ordering box receiving streaming directly from a server.

### DETAILED DESCRIPTION OF THE INVENTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments, if any, do not inherently indicate any particular order nor imply limitations in the invention.

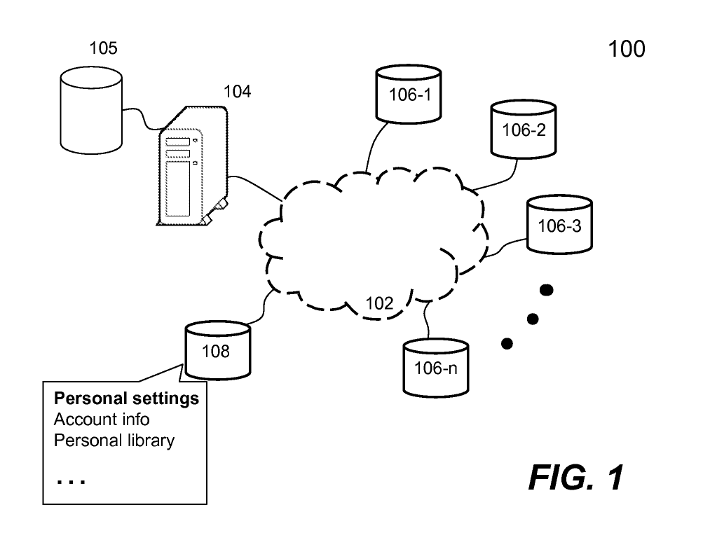

Referring now to the drawings, in which like numerals refer to like parts throughout the several views. FIG. 1 shows an exemplary configuration 100 in which the present invention may be practiced. Coupled to the network 102, there are a server 104 and a plurality of local machines or boxes 106-1,106-2,106-3, . . . 106-n and 108. Each of the boxes 106-1,106-2,106-3, . . . 106-n and 108 includes or connected to a display screen (not shown) and a local storage space (not separately shown). The boxes 106-1,106-2,106-3, . . . 106-n and 108 may be located remotely with respect to each other. With each of the boxes 106-1,106-2,106-3, . . . 106-n and 108, a subscriber or a user may receive multimedia services from the server 104 that is typically operated by a service provider.

It is assumed that the box 108 is a primary box from which a user orders and receives services from the server 104. The box 108 may be located in a residence of the user. Typically, the user maintains an account with the server 104. From time to time, the user may update the account from the box 108. Whenever there is a change to the account, a copy of the account information maintained in the server 104 is updated accordingly.

According to one embodiment of the present invention, the user is allowed to establish his or her own account preferences that include, but not limited to, look and feel of a graphic user interface, a viewed list, a list of orders, and a personal vault. A graphic user interface provides an environment in which the user interacts with the media services being offered. A viewed list includes a list of movie titles that the user has viewed or browsed in the past. A list of orders may includes movie titles the user desires to order. A vault or a personal library includes a list of movies that may have been purchased or rented by the user. Any of the titles in the vault may be accessed by the user at any time or in any way (e.g., re-watching a movie or making a copy on a DVD disc).

One of the features, benefits and advantages in the present invention is to provide a mechanism that allows the user to access his or her account preference at anytime from anywhere. Whether the user logs into his or her account from the box 108 or any one of the boxes 106-1,106-2,106-3, . . . 106-n, the user sees the same personalized settings as if any one of the boxes 106-1,106-2,106-3, . . . 106-n was the primary box 108.

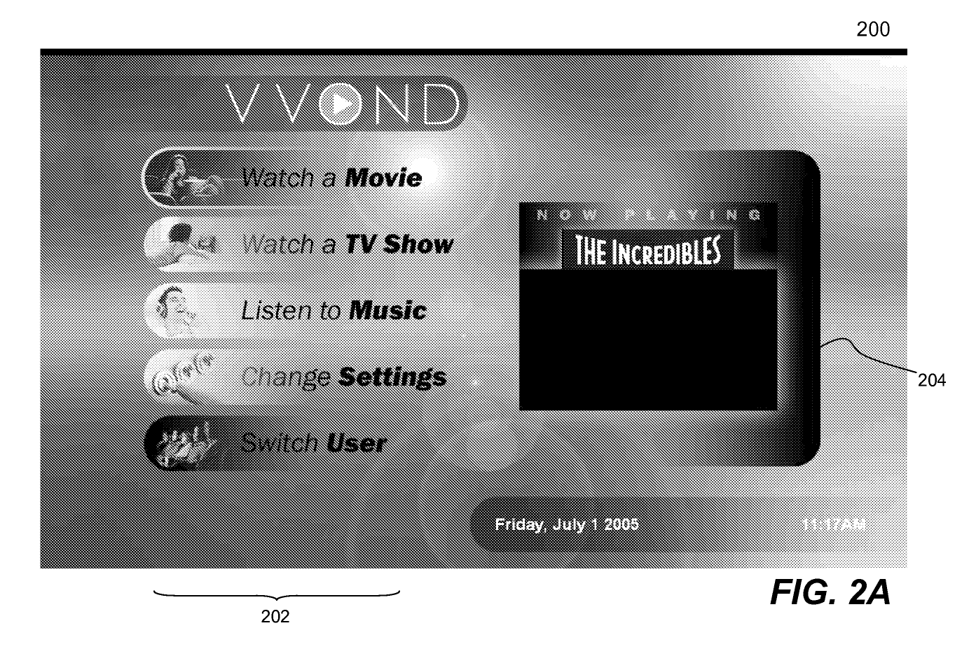

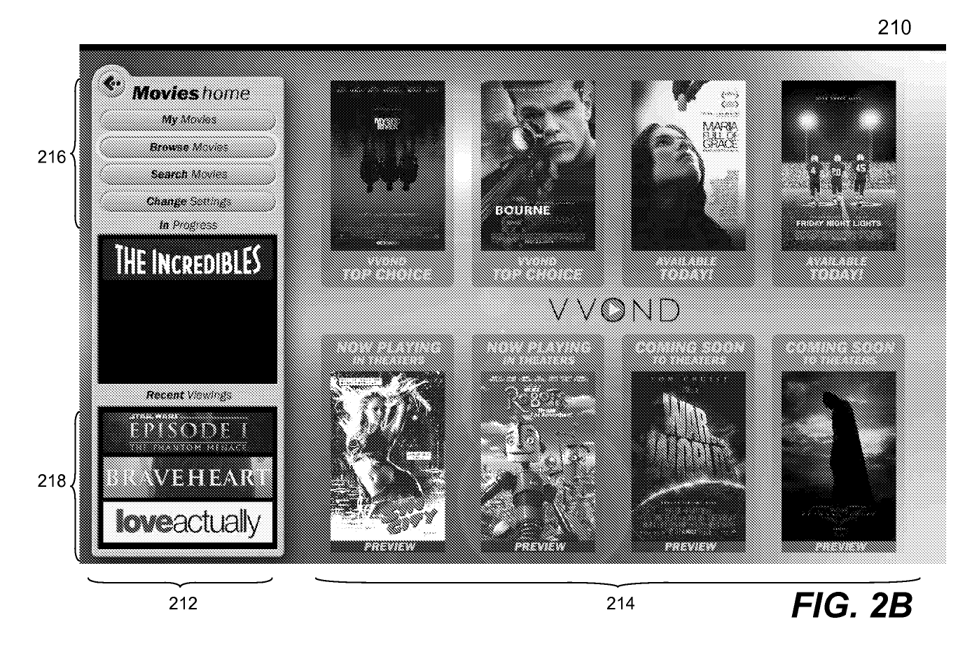

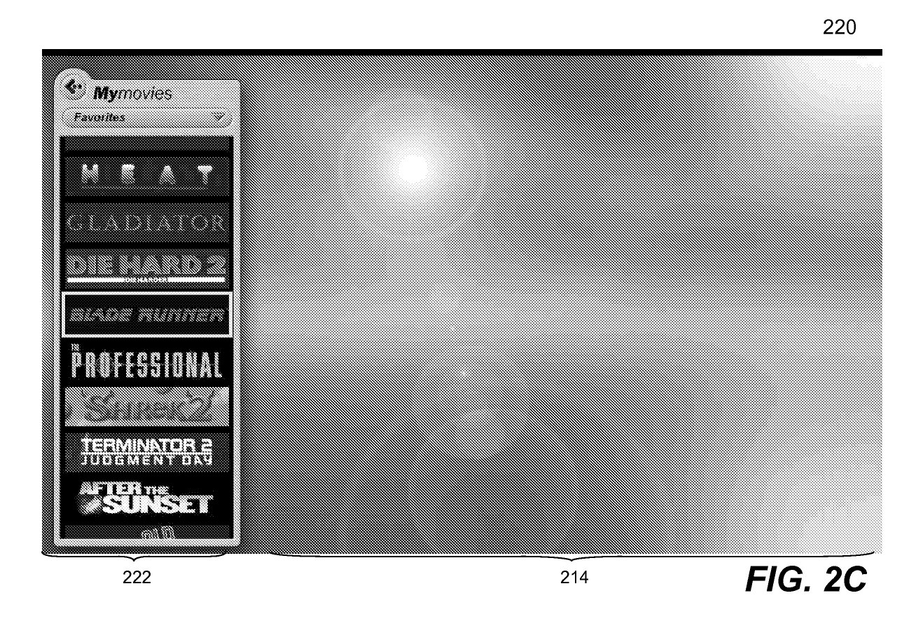

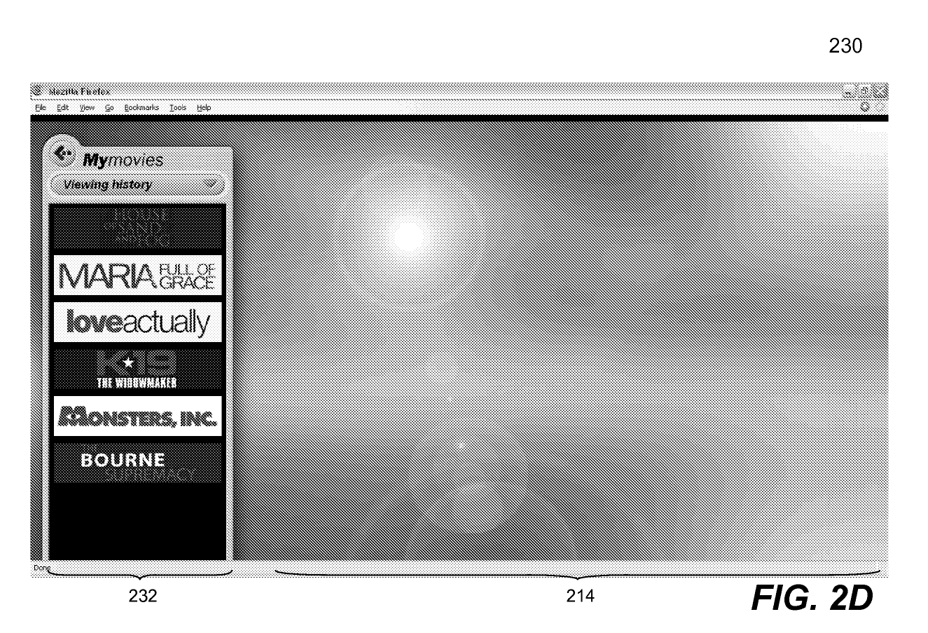

One of the features in the present inventions is that, regardless where a user logs into the account, the user always sees substantial similar settings in the account as if the user was using the primary box. FIGS. 2A-2D show exemplary displays pertaining to a user account. FIG. 2A shows a display 200 providing a list 202 of services provided by a service provider. The display 200 and any subsequent displays are image displays on a display screen that may be part of a computing device or a television, or coupled to a device. It should be noted that it is defined herein a display screen or a screen is a physical display apparatus, such as a CRT or LCD television commonly seen and available. A screen display or simply a display is a displayed image or a displayed window presented on the display screen.

The display 200 shows that a user may enter into any of five areas: Watch a Movie, Watch a TV Show, Listen to Music, Change Settings, and Switch User. As the name suggests, Watch a Movie allows a user to order a movie from a plurality of titles in a library, Watch a TV Show and Listen to Music allow a user to choose a particular channel for TV broadcasts and music, live or archived, Change Settings is provided to change various settings for the account from which the user may access the services, and Switch User allows a change from one user account to another. Some of the areas will be detailed below.

Next to the list 202, according to one embodiment, the display 200 includes a smaller display window 204, referred to as an iconic display, showing whatever is being played or promoted. It is assumed that a user enters Watch a Movie. FIG. 2B shows an exemplary display 210, also referred to herein as a home display, after the user enters Watch a Movie. The display 210 includes a functional panel 212 and a notification space 214. The functional panel 212 includes various tools 216 to facilitate a user to manage personalized lists and/or minor accounts if necessary, search a movie and change settings, etc. In addition, the functional panel 212 includes a list of recent movies 218 that the user has viewed. In accordance with FIG. 2A, the movie that is currently being played is displayed in an iconic display 220 that is also included in the functional panel 212.

The notification space 214 is provided to display various promotions. The embodiment as shown in the display 210 shows that there are eight movies being promoted. In another embodiment, the notification space 214 is used to advertise various services and products. These services and products may be highly related to the interests or characteristics of the account owner. When an account is established for the owner, a list of questions may be generated for the owner to answer. The answers from the owner to the questions are assembled and analyzed to determine the interests or characteristics of the owner. For example, some answers indicate that the owner is very much into golfing, the notification space 214 may be configured to display services and products somehow related to golfing. The interests or characteristics of the owner may also be determined from an analysis of the owner's behavior in interacting with the system, together with additional information provided to the system about the behavior of other owners.

As shown in FIG. 2B, the movies being promoted in the notification space 214 are in the form of movie posters. One of the advantages of showing movie posters instead of titles in words is to make a coincident impact on audience as a movie poster is a single visual image representation of a movie. Movie studios or production companies, large or small, promote their movies with movie posters so that the general audience gets to know a movie quickly from a corresponding movie poster. According to one implementation, each of the displayed movie posters in the notification space 214 is embedded with a link. Once one of the displayed movie posters is selected, a full review of the movie is provided.

My Movies, Browse Movies, and Search Movies in the functional panel 212 provide respective mechanisms for a user to locate a movie. My Movies is a personal directory providing a vault to store or bookmark one or more movies favorite to the owner of the account. According to one embodiment, when a user is interested in a movie when browsing the library offered, the movie may be bookmarked in My Movies so that the user can always go back to My Movies to readily place an order for the movie. FIG. 2C shows a display 220 including a list 222 in My Movies. Instead of using words for a title of a movie, the display 220 shows a list of movie banners, each banner representing a visual image of the movie. A movie banner may be part of a corresponding movie poster or a redesigned banner that reflects certain characteristics of the movie.

As shown in the list 222 in My Movies, each of the movie banners shows a title in substantially similar style, font and background as in the corresponding movie poster. One of the purposes of using at least part of a movie poster or banner instead of texts to indicate a movie is to create a coincident impact on the audience. In certain aspect, a movie banner is equivalent to a visual “logo” for a movie. A user may browse or scroll the list of movie banners in the list 222. Each of the movie banners in the list 222 is embedded with a link that brings up a full review of the movie when one of the displayed movie banners is selected.

After a certain arrangement with the service provider is made, the user may gain a limited right to access one or more movies in My Movies repeatedly without charges or with a nominal change. According to one embodiment, the movies in My Movies are purchased and owned by the account owner. The account owner may access any one of the movies in My Movies from anywhere at any time without charges. When the account owner logs into the account from a box other than the primary one, all the movies in My Movies shall be immediately available, which in reality creates the challenge of how to duplicate the movies in My Movies.

FIG. 2D shows a display 230 including a viewing history 232 in My Movies. The viewing history 232 is provided to record what movie the user has ordered or watched. Similar to the favorite list 222 in FIG. 2C, the viewing history 232 shows a list of movie banners reflecting that these movies have been watched or ordered. Each of the movie banners in the list 232 is also embedded with a link that leads to a full review of the movie when activated. Such a favorite list 222 shall be also immediately available when the account owner logs into the account from a box other than the primary one.

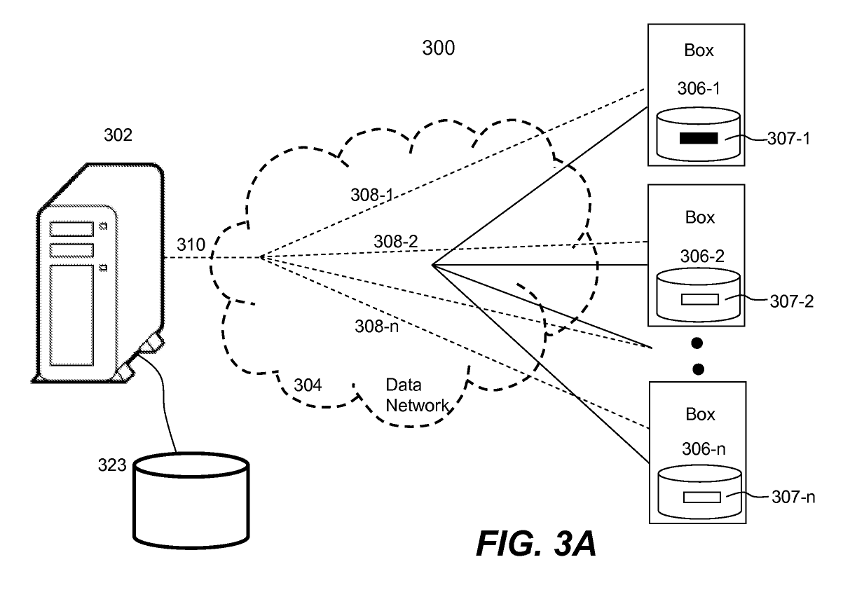

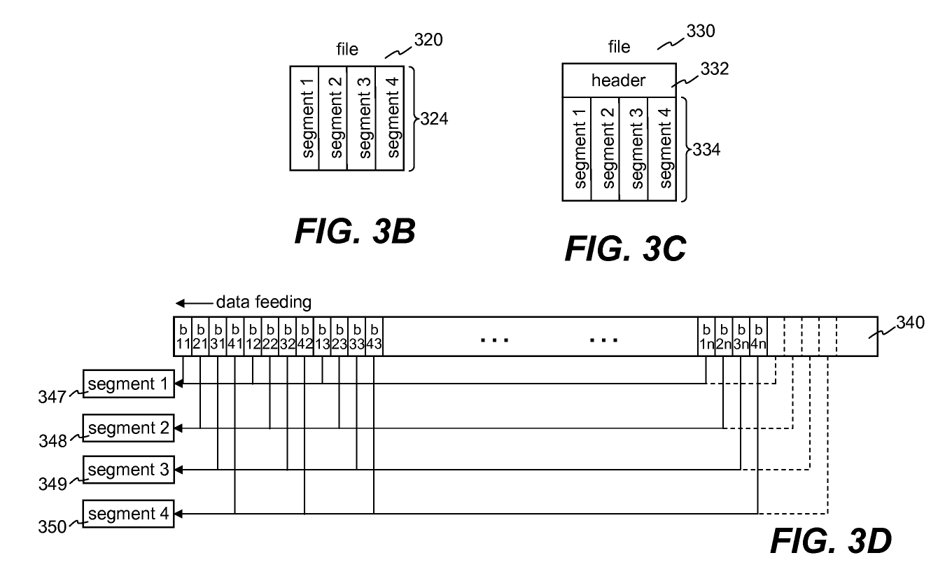

FIG. 3A shows an exemplary configuration 300 to implement one embodiment of the present invention. One of the features, benefits and advantages of the configuration 300 is the underlying mechanism that utilizes the computing capacity as well as the bandwidth on the client side to deliver media services while, at the same time, providing centralized services and management.

For example, the architecture 300 may be configured to deliver non-prerecorded programs such as live broadcasts by a multicasting protocol. The server 302 receives orders from some of the subscribers (e.g., for boxes 306-1 and 306-n) for a broadcasting event. When the event comes, the server 302 receives a streaming feed from a source (e.g., a televised site). The streaming is then delivered by the server 302 via the network path 310 to 308-1 and 308-n to the ordering boxes 306-1 and 306-n. As the subscriber for the box 306-2 did not order the event, the box 306-2 will not receive the streaming from the server 302. It can be appreciated that the number of recipients for the program does not affect the performance of the server 302 or demands higher bandwidth because the program is being multicast to the ordering boxes.

At the same time, the architecture 300 can provide prerecorded programs such as movies without demanding higher bandwidth when servicing a large number of boxes. In operation, the server 302 is not responsible for delivering the content in response to a request from an ordering box (e.g., 306-1), and instead is configured to provide source information as to where and how to retrieve at least some of the content from other boxes. In other words, some of the other boxes 306-2, 306-3, . . . 306-n are respectively configured to supply part or all of the content to each other.

The segments for each title in a library are distributed among the boxes in service. When the box 306-1 is used to order one of the titles in a library, the request is sent to the server 302 via the network path 308-1 and 310. The server 302 is configured to determine which other boxes are most appropriate to be the suppliers for providing the distributed segments. Either the server 302 causes the suppliers to contact the ordering box 306-1 to receive the needed segments or the ordering box 306-1 initiates communication with the suppliers upon receiving a response form the server 302, where the response includes information about the suppliers. In one embodiment, the information includes designation information (e.g., network addresses) as to who are the suppliers, security information as to how to decrypt the data, and other information to facilitate the playback of the ordered title.

For convenience, it is assumed herein that a file representing a collection of data pertaining to a movie title. When an order for a title is placed, corresponding data from the file must be available for playback. According to one aspect of the present invention, only a beginning portion (referred to as a “header”) and possibly one or more tail segments of a file are locally cached in a box. Such locally cached segments are referred to as residing segments, while segments not residing locally are referred to as distributed objects or segments. When a title is selected, the header of the corresponding file is instantly played back. During the time the header is being played, the distributed objects corresponding to the title are retrieved simultaneously from other boxes. When the header is finished, the received parts of the distributed segments being streamed in from other boxes are combined with the residing segments for the title, if any, to enable a continuous playback. Depending on the popularity and concurrent demand for a particular title, the number of residing objects may be increased or decreased to control the dependency of each box on other boxes for playback. Typically, the more residing objects for a title a box has, the more distributed copies of the title there are in the entire system and thus the less dependency of the ordering box on the other boxes.

In one embodiment, the header is always played first to ensure instant playback. In another embodiment, the header size is reduced to zero, in which case, a time-fill program may be played first to provide a time frame that is sufficient enough to fetch and assembly the beginning data portion of the segments either locally available or from other boxes. Depending on implementation, the time-fill program may include one or more trailers related to the title being ordered, various notifications/updates or commercial programs.

Referring to FIG. 3B, there shows an embodiment in which a file 320 is being organized or fragmented in terms of four segments 324. In general, the file 320 representing a collection of all data pertaining to a title may be divided into any number of segments in consideration of a required transmission rate (e.g., related to the encoding and decoding rates for successful playback), and the minimum uploading and downloading capabilities of a network. FIG. 3C shows another embodiment in which a file 330 is being organized or fragmented in terms of a header 332 and four segments 324, where the header 332 is always locally cached. One of the advantages of having a header locally cached is to facilitate an instantaneous playback after a movie is order. While the header is being played back, the needed segments are retrieved from other designated boxes. It can be appreciated the length of a header may be predefined or dynamically determined to provide a time buffer (e.g., 5 minutes) sufficiently to retrieve part of the data from the distributed segments for assembling with that of any locally cached segments, if any. As a result, an instantaneous VOD system may be realized.

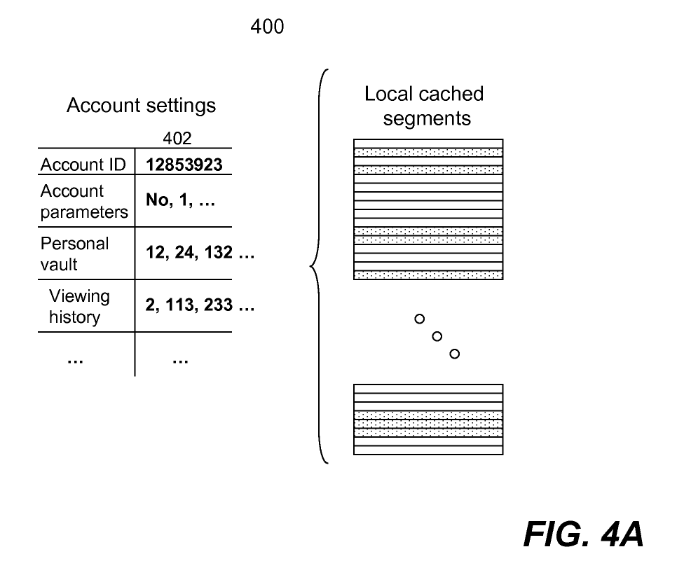

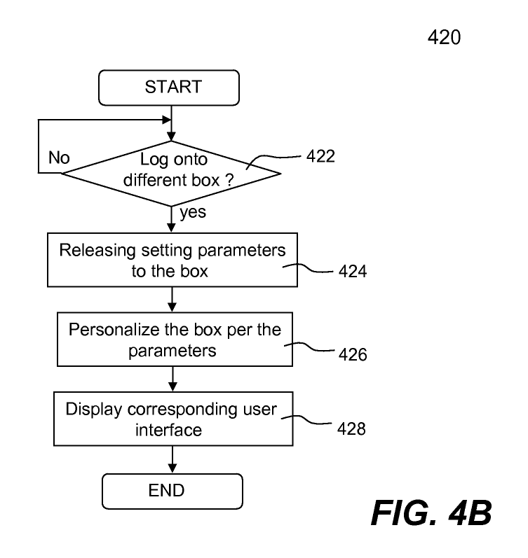

According to one embodiment, FIG. 4A shows an illustration 400 of a personal settings table 402 that includes a number of characters and numerals. Depending on implementation, each of the characters and numerals pertains to one or more parameters that control an account associated with a subscriber. As an example as shown in FIG. 4A, an account ID 12853923 indicates an account associated with a subscriber. Numerals and characters No, 1, . . . may mean that the account is not restricted (i.e., “No” means that all titles are accessible), and the account is set up in category “1” which may mean that the account is in a box type one (e.g., a predefined storage size, a memory map, resolutions, a primary language, a time zone, etc.). Numerals or characters 12, 24, 132 . . . identify movies or segments locally cached for the movies in the personal vault in the primary box associated with the subscriber. Numerals or characters 2, 113, 233 . . . are identifiers of movies that the subscribers may have ordered or browsed. Other data not shown may include, but not be limited to, information about color of the graph user interface (GUI), classifiers determining what movies or commercial advertisements can be promoted, a list of movies the subscriber desires to watch or order or recommended by someone (e.g., a service provider based on past viewing habits or a guardian if the account is for a minor), or personal or audience ratings of the movies watched.

In one embodiment, a subscriber maintains a list of movies in a vault. These movies may have been purchased or rented and shall be available immediately. To make it possible to instantaneously access these movies, all segments pertaining to the movies are preferably locally cached for certain operations. The shaded segments as shown in FIG. 4 indicate those locally cached segments for movies in a vault. When the subscriber, for example, desires to make an optical disc (e.g., DVD) of a purchased movie in the vault, the disc could be made without causing the primary box to be connected to a server or a network for missing data. However, when the subscriber logs into his/her account from another or a new box, a personal settings table associated with the subscriber is downloaded in to the new box. Most of the personal settings can personalize the new box for the subscriber within a few seconds. Depending on the cached segments in the new box, some movies in the vault may not have all the segments locally cached. If the subscriber needs to make a DVD of one of the movie, a message may be posted to indicate that such process will be delayed or be available after a certain time. According to one embodiment, whenever the new box is not used for any downloading or there is some downloading bandwidth available, the new box is configured to fetch those missing segments. It should be noted that watching any of the movies in the vault is not affected as long as network connection is available.

FIG. 4B shows a flowchart 430 of managing personalized setting across network. The process 420 may be implemented in software, hardware or a combination of both. According to one embodiment, a user, for whatever reason, logs into his/her account from a box other than the one he/she has been using. The user may use a means to provide credential information to cause the new box to send a login request to a server. For example, the user may insert a smartcard into a slot of the box or type in a set of username/password. Upon receiving provided credential information from the user (e.g., via the smartcard), the box is configured to generate a login request that includes the credential information as well as an identifier (e.g., an IP address) of the box. The login box is then forwarded to a server. In one perspective, a smartcard is perceived to carry with it an entire library of many movie titles.

Upon receiving the request, the server performs at 422 whether the user has logged into a box other than his/her primary box by comparing the received identifier and an identifier of the primary box maintained at the server. If the identifiers are identical, which means that the user is using the primary box, there is no need to personalize the primary box, because the primary box is where the personalized settings are maintained or managed. In operation, wherever there is a change to the personalized settings, a copy of the change or updated settings is sent to the server for synchronization.

At 422, it is assumed that the identifiers are not identical, which means the box the user just logged on is not the primary one. At 424, a copy of the personalized settings is located and uploaded to the box. Upon receiving the personalized settings, the box is configured to personalize itself in accordance with the personalized settings at 426. For example, the box displays or causes to display a graphic user interface (e.g., a particular style, a color or fonts). As a result, the user sees substantially similar account preference he/she is used to at 428.

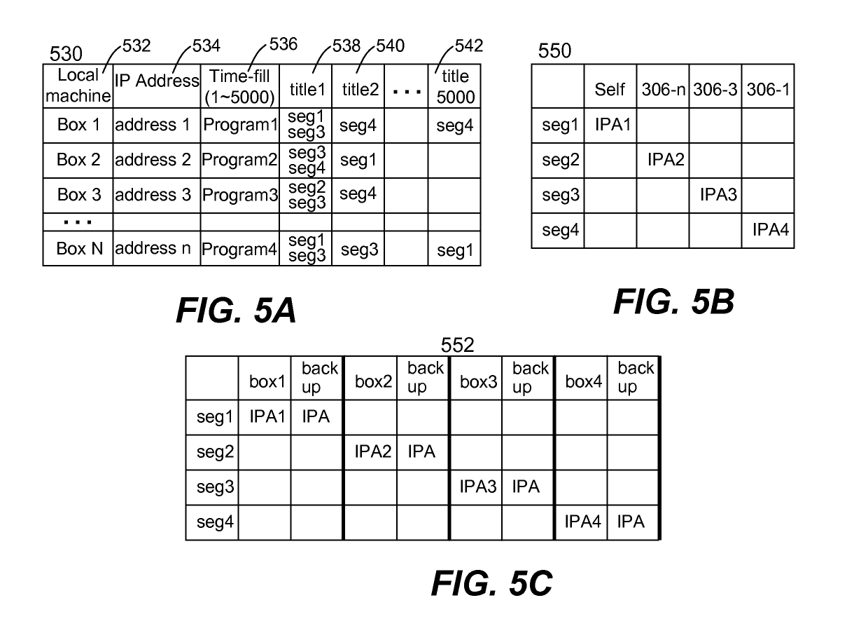

Referring now to FIG. 5A, there shows exemplary source information shown as a map 530 illustrating how a library of 5000 movie titles is distributed across N boxes. Column 532 lists all boxes in service. Each box is assigned a unique identifier for identification. Information in the column 532 may be viewed as the identifiers for the boxes in service. For example, box 1 is assigned a unique identifier of “Box 1” or a sequence of alphanumeric characters. The column 534 lists a corresponding IP address for each of the boxes listed in column 532. The Column 536 lists predetermined time-fill programs for all titles in the library. Depending on implementation, the time-fill programs may be identical or each of the time-fill programs is self-configured in accordance with what has been ordered. The column 538 lists what segments for title1 are residing in each of the boxes, assuming title1 is required to have two segments cached in each box. The column 540 lists what segment for title2 is residing in each of the boxes, assuming title2 is required to have one segment cached in each of the boxes. The column 542 lists what segment for title5000 is in a selected set of boxes, assuming title5000 is required to have one segment in these selected boxes. As a result, all segments in a box may be uniquely addressed for uploading to another box or playback of an ordered title locally.

FIG. 5B shows a source information map 550 corresponding to FIG. 5A. There are three other boxes 506-n, 506-3 and 506-1 designated to supply three needed segments that are together assembled with a locally cached segment to facilitate the playback of the ordered movie. It can be appreciated that relying on multiple sources to retrieve distributed segments to support a playback can be advantageously used in the architecture of current networks where the downloading bandwidth is typically a multiple of the uploading bandwidth.

FIG. 5C shows exemplary source information with backup boxes in a table 552 that includes a backup identifier (shown as an IP address) for each of the designated boxes. Should one of the boxes fail to respond to the request for a segment from the ordering box or the segment cannot be received correctly, the backup IP address is immediately called upon to switch to the corresponding backup box that is available to provide or continue to provide a segment that the originally designated box fails to provide.

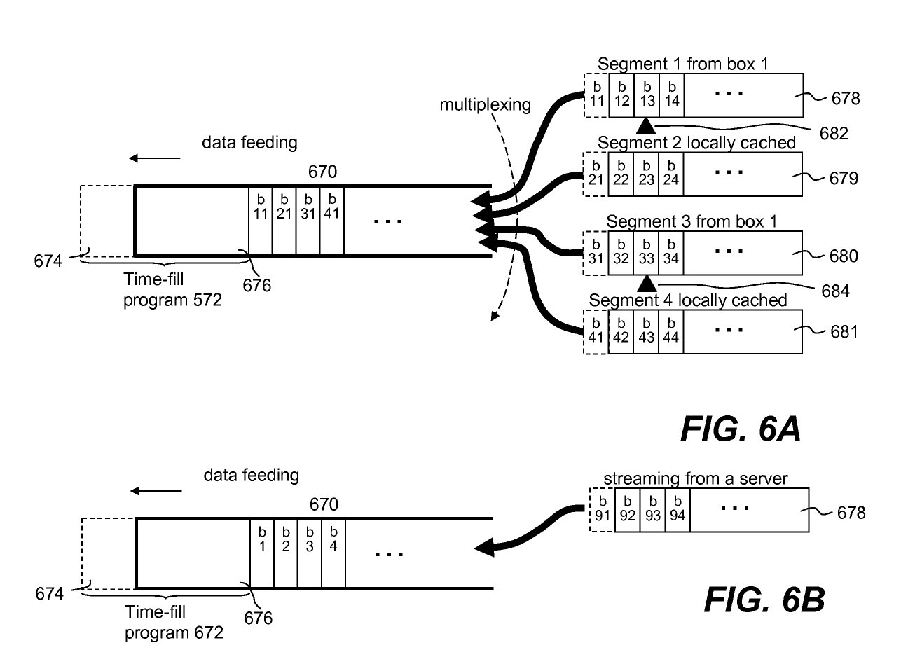

Referring now to FIG. 6A, there shows an embodiment of an ordering box retrieving and assembling segments to support a playback of a selected movie. If all segments are streaming at predetermined minimum speeds, then, at 656, portions of the segments locally stored and the portions of the segments being streamed in are multiplexed into a buffer as shown in FIG. 6A. A portion 674 of the time-fill program 672 has been played out of the buffer 670. The remaining portion 676 of the time-fill program 672 is yet to be played. At the same time, the streaming of segments 678 and 680 is being fed into the buffer 670. Segments 678-681 (including the segments locally stored and the segments being streamed in) are multiplexed into the buffer 670. More specifically, a block of data from segment 1, a block of data from segment 2, a block of data from segment 3 and a block of data from segment 4 are multiplexed and successively fed into the buffer 670. As a result, the original order of the data is restored and the remaining portion of the file pertaining to the title is assembled.

To facilitate the continuation of a data stream, each of the pointers 682 and 786 is used to remember where the data block of a segment is being fed or about to be fed to the buffer 670. In the event, the segment being fetched from a box is interrupted and a backup box needs to step in, the ordering box knows exactly where to start fetching the segment from where it was interrupted in accordance with the pointer. Likewise, similar pointers (not shown) may be provided to remember where the data block of the locally cached segment is being fed or about to be fed to the buffer 670. In the event, the ordering box needs to be reset or is suddenly powered off and back on, these pointers can facilitate the continuation of the playback of the ordered movie.

FIG. 6B shows an embodiment of an ordering box receiving streaming directly from a server. Different from the multiplexing operation shown in FIG. 6A, the ordering box is configured to buffer the data of the streaming into the buffer 670 that is provided to minimize any possible instability or interruption of the streaming. In operation, once an order is placed, a time-fill program 672 is instantly played. At the same time, a data sequence from a server is being fetched and put into the buffer 670. As soon as the time-fill program 672 is done, the buffered portion of the data is started. Not shown in FIG. 6B, data pointers may be used in FIG. 6B to facilitate the continuation of the playback of the data in case the ordering box is accidentally out of operation and turned back on.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, some elements in a display may include one or more sub-elements. When such an element is selected, the display appearance of the element may be highlighted in a way that enables the user to navigate into the sub-elements to select one of the sub-elements or group one or more of these sub-elements. Accordingly, the scope of the present invention is defined by the appended claims rather than the foregoing description of embodiments.

We claim:

1. A method for keeping personalized settings across network, the method comprising:
determining whether a user has logged into a box other than a primary box, where the primary box is configured to manage personalized settings that dictate a graphic user interface from which the user accesses various media services; and
when the user is logged into the box other than the primary box, uploading a copy of the personalized settings to the box that is configured to respond to the personalized settings such that the user sees substantially similar settings as if the user has logged into the primary box.

2. The method as recited in claim 1, wherein the personalized settings includes parameters controlling what the media services are or are not accessible.

3. The method as recited in claim 2, wherein the personalized settings further pertain to a vault that includes items purchased or rented by the user.

4. The method as recited in claim 3, wherein each of the items is represented by a plurality of segments, each of the segments including data blocks that are not sequential, for each of the items to be played back, the data blocks in each of the segments shall start to be available for being multiplexed to recover an original data stream for a playback of the each of the items.

5. The method as recited in claim 4, further comprising:
determining whether the box has enough bandwidth to fetch one or more missing segments pertaining to one of the items in the vault; and
starting fetching the one or more missing segments from other boxes in service.

6. The method as recited in claim 4, wherein the personalized settings also include information regarding one or more of a list of movies the user desires to watch or order, a list of recommended movies, personal or audience ratings of the movies watched.

7. The method as recited in claim 1, further comprising:
receiving a login request from the box, the login request including an identifier identifying the box and credential information associated with the user who has provided to the box.

8. The method as recited in claim 7, wherein said determining whether a user has logged into a box other than a primary box comprises:
comparing the identifier with a primary identifier identifying the primary box after the user is authorized to log into the box; and
causing a copy of the personalized settings to be loaded into the box when the identifier is not identical to the primary identifier.

9. The method as recited in claim 8, further comprising:
identifying what necessary data segments are missing; and
providing a source information map to the box for possible downloading of the necessary data segments from one or more other places.

10. The method as recited in claim 7, wherein said determining whether a user has logged into a box other than a primary box comprises requiring an insertion of a smartcard into the box, wherein the smartcard is perceived to have carried with it an entire library of movies being provided after the user has been authenticated.

11. A system for keeping personalized settings across network, the system comprising:
a first box configured to manage personal settings for an account associated with a user, wherein the personalized settings dictate a graphic user interface from which the user accesses various media services;
a second box, operating independently from the first box, being logged in by the user; and
a server determining whether the user has logged into the first box or the second box when receiving a login request, when the user is logged into the second box, the server uploading a copy of the personalized settings to the second box that is configured to respond to the personalized settings such that the user sees substantially similar settings as if the user has logged into the first box.

12. The system as recited in claim 11, wherein the personalized settings includes parameters controlling what the media services are or are not accessible.

13. The system as recited in claim 12, wherein the personalized settings further pertain to a vault that includes items purchased or rented by the user.

14. The system as recited in claim 13, wherein each of the items is represented by a plurality of segments, each of the segments including data blocks that are not sequential, for each of the items to be played back, the data blocks in each of the segments shall start to be available for being multiplexed to recover an original data stream for a playback of the each of the items.

15. The system as recited in claim 14, wherein the second box is configured to perform operations of:
determining whether the second box has enough bandwidth to fetch one or more missing segments pertaining to one of the items in the vault; and
starting fetching the one or more missing segments from other boxes in service.

16. The system as recited in claim 14, wherein the personalized settings also include information regarding a list of movies the user desires to watch or order, personal or audience ratings of the movies watched.

17. The system as recited in claim 11, wherein the server receives a login request from the second box, the login request including an identifier identifying the second box and credential information associated with the user who has provided to the second box.

18. The system as recited in claim 17, wherein the server is configured to perform operations of:
comparing the identifier with a primary identifier identifying the first box after the user is authorized to log into the second box; and
causing a copy of the personalized settings to be loaded into the second box when the identifier is not identical to the primary identifier.

19. The system as recited in claim 18, wherein the server is configured to perform operations of:
identifying what necessary data segments are missing; and
providing a source information map to the second box for possible downloading of the necessary data segments from one or more other places.

20. The system as recited in claim 19, wherein the one or more other places include other boxes or servers.
